(19) United States
(12) Patent Application Publication
(10) Pub. No.: US 2014/0195096 A1
(43) Pub. Date: Jul. 10, 2014

(54) APPARATUS AND METHOD FOR CONTACTLESSLY DETECTING OBJECTS AND/OR PERSONS AND GESTURES AND/OR OPERATING PROCEDURES MADE AND/OR CARRIED OUT THEREBY

(71) Applicants: Frank Schliep, Leverkusen (DE); Oliver Kirsch, Wuppertal (DE); Yanning Zhao, Burscheid (DE)

(72) Inventors: Frank Schliep, Leverkusen (DE); Oliver Kirsch, Wuppertal (DE); Yanning Zhao, Burscheid (DE)

(73) Assignee: JOHNSON CONTROLS GMBH

(21) Appl. No.: 14/129,866

(22) PCT Filed: Jun. 29, 2012
(86) PCT No.: PCT/EP2012/062781

§ 371 Date: Mar. 18, 2014

(30) Foreign Application Priority Data
Jun. 30, 2011 (DE) 10 2011 106 058.1
Aug. 19, 2011 (DE) 10 2011 111 103.8
Dec. 20, 2011 (DE) 10 2011 089 195.1

(51) Int. Cl. B60K 35/00; G06F 3/01; G06F 3/042

(52) U.S. Cl. CPC B60K 35/00; G06F 3/0425; G06F 3/017
USPC 701/29.1; 345/175

(57) ABSTRACT

An apparatus for contactlessly detecting objects and/or persons and gestures and/or operating procedures made and/or carried out thereby, is arranged in a vehicle interior and includes at least one lighting unit, a display unit and an optical detection unit. The lighting unit is formed from at least one infrared laser diode.

The invention relates to an apparatus for contactlessly detecting objects and/or persons and gestures and/or operating procedures made and/or carried out thereby according to the preamble of claim 1. The invention furthermore relates to a method for contactlessly detecting objects and/or persons and gestures and/or operating procedures made and/or carried out thereby according to the preamble of claim 9.

It is generally known that the interior of motor vehicles contains a multiplicity of functions that are controllable by vehicle occupants. Such functions include an air conditioning system, entertainment electronics, communication media such as, for example, a cellular phone and internet applications, and a navigation system.

For controlling and displaying these functions, various input and output apparatuses are known from the prior art. In this case, use is made, in particular, of input and output apparatuses which are designed as touch-sensitive display units (touch screens) or display units with a touch-sensitive input and/or output apparatus (touch panel) attached in front. These display units, or input and/or output apparatuses, can be e.g. of resistive or capacitive design.

With touch-sensitive display units of capacitive design, or touch-sensitive input and/or output apparatuses of capacitive design, a capacitive proximity method (also known as “proximity sensing”) is furthermore possible, by means of which, for example, it is possible to realize anti-trap protection of vehicle occupants when closing windows and/or doors and/or, in particular, a differentiation of vehicle occupants, e.g. between driver and passenger. The latter case might involve, for example, using a key of the display unit for zooming a navigation device, which key is disabled for operation by the passenger.

Particularly the interaction between the driver and the display units described above is becoming more and more complex, as a result of which intelligent and/or intuitive operating concepts are required.

Furthermore, the prior art discloses systems for identifying seat occupation which detect a vehicle occupant situated on the vehicle seat by means of a sensor arranged in the vehicle seat.

DE 10 2007 028 645 A1 describes an arrangement and a method for controlling device units, wherein, by means of a sensor unit, gestures of an object are captured and interpreted and the interpreted gestures are converted into control signals for controlling the device unit.

The problem addressed by the present invention is that of specifying an apparatus that is improved compared with the prior art and an improved method for contactlessly detecting objects and/or persons and/or gestures and/or operating procedures made and/or carried out thereby.

With regard to the apparatus for contactlessly detecting objects and/or persons and gestures and/or operating procedures made and/or carried out thereby, the problem is solved by means of the features specified in claim 1.

With regard to the method for contactlessly detecting objects and/or persons and gestures and/or operating procedures made and/or carried out thereby, the problem is solved by means of the features specified in claim 9.

The dependent claims relate to advantageous developments of the invention.

In the apparatus for contactlessly detecting objects and/or persons and gestures and/or operating procedures made and/or carried out thereby, according to the invention the apparatus is arranged in a vehicle interior and comprises at least one lighting unit, a display unit and an optical detection unit, wherein the lighting unit is formed from at least one infrared laser, in particular an infrared laser diode. Advantageously, an object and/or a person and/or gestures and/or operating procedures made and/or carried out by said person can be detected three-dimensionally by means of the optical detection unit. By way of example, a movement of a vehicle driver's hand or finger is thus detected three-dimensionally, said movement corresponding, for example, to a virtual actuation of a display unit in the vehicle. This can involve the detection of an operating procedure using a gesture, such as, for example, a finger being moved to and fro or a swiping movement or opening of the hand as zoom movement.

Conventionally, a plurality of light-emitting diodes are used as lighting unit. In comparison therewith, the infrared laser diode used according to the invention has an improved coherence and a higher power spectral density, thus resulting in a higher modulation bandwidth and more effective optical filtering. A significantly improved resolution of the optical detection unit is advantageously made possible thereby, as a result of which more complex gestures of the vehicle occupants can be detected.

The detection unit converts the detected gesture or movement into a corresponding electrical signal and communicates the latter to a controller, for example of a conventional display unit, which carries out the desired operating procedure in accordance with the information contained in the electrical signal.

Such a display unit comprises at least one display panel and a control unit. A touch-sensitive display unit can thus be emulated by means of the apparatus, said display unit enabling an emulated capacitive proximity method, e.g. for distinguishing whether the display unit is operated by the driver or passenger. The three-dimensional detection of the operating procedures furthermore makes it possible to save memory space in the display unit. This makes it possible to reduce production costs and complexity of the display unit.

Furthermore, it is not necessary for a touch-sensitive input and/or output apparatus (touch panel) to be cost-intensively linked to a screen constituting a possible exemplary embodiment for producing a touch-sensitive display unit.

Furthermore, an output quality of the display unit with regard to lighting conditions is improved compared with touch-sensitive display units, since the latter usually consist of a plurality of layers which partly reflect the backlighting.

Expediently, the optical detection unit comprises at least one optical sensor.

The optical detection unit is particularly preferably designed as a three-dimensional camera system by means of which a time-of-flight method for distance measurement can be carried out. By way of example, the optical detection unit is designed as a so-called time-of-flight (TOF) camera comprising the lighting unit, at least one optical element, at least one optical sensor and corresponding electronics for driving and evaluation.

The principle of the TOF camera is based on a time-of-flight method for distance measurement. For this purpose, by way of example, a vehicle interior or part of the vehicle interior is illuminated by means of a light pulse generated by the lighting unit, in particular the laser diode, wherein the TOF camera measures for each pixel the time required by the light to propagate to the object and back again to the optical sensor. Preferably, the required time is proportional to the corresponding distance. On the optical sensor, the detected scene, in particular the detected operating procedure, is imaged and subsequently evaluated correspondingly. In this case, the TOF camera is very robust and adaptable and supplies 3D data.

Particularly preferably or alternatively, the optical detection unit is designed as a stereo camera, in particular as an infrared stereo camera, by means of which an operating procedure can be optically detected three-dimensionally.

In this case, the at least one optical sensor is particularly preferably designed as a photomixing detector. Light in an infrared range can be detected by means of the optical sensor. In this case, the optical sensor is preferably integrated in the TOF camera or coupled thereto. By way of example, the optical sensor can be arranged in the roof console of a vehicle. As an alternative thereto, the optical sensor can also be oriented in the direction of the driver in an interior console or be arranged in the instrument panel or in a headrest of a vehicle or in an A-pillar.

In an alternative embodiment, the optical detection unit is designed as a so-called structured light scanner, in which an infrared light grid is applied to a vehicle occupant. An energy consumption can preferably be reduced by means of the scanner.

Particularly preferably, the optical sensor is integrated in the three-dimensional camera system (TOF) or the stereo camera or is coupled thereto.

The display unit is preferably designed as a head-up display in a vehicle driver's field of view, such that the information represented can be detected by the vehicle driver intuitively and without changing the viewing direction. For this purpose, the display unit is designed as a so-called head-up display or alternatively as a combined head-up display, also designated as combiner head-up display, and is arranged for example in or on the windshield of a vehicle.

In the method for contactlessly detecting objects and/or persons and gestures and/or operating procedures made and/or carried out thereby, according to the invention an object and/or a person and/or gestures and/or operating procedures made and/or carried out by said person are detected three-dimensionally in a vehicle interior by means of an optical detection unit.

Particularly advantageously, a touch-sensitive display unit is emulated by means of an apparatus according to the invention, said display unit enabling an emulated capacitive proximity method for distinguishing whether the display unit is operated by a vehicle driver or some other person.

Depending on a diaphragm aperture and/or the construction of the optical detection unit, the latter is controllable in a supervised manner, e.g. by means of a switch, and can be used for detecting a head movement and/or a viewing direction, e.g. of a vehicle driver. On the basis of the detected head movement and/or viewing direction, tracking or adjustment of the headrest can furthermore be effected and/or a distraction of the vehicle driver from the current traffic situation can be detected. Preferably, corresponding actions, for example warning signals, can then be activated, as a result of which traffic safety is increased.

The invention is explained in greater detail below with reference to the accompanying schematic drawings.

In this case:

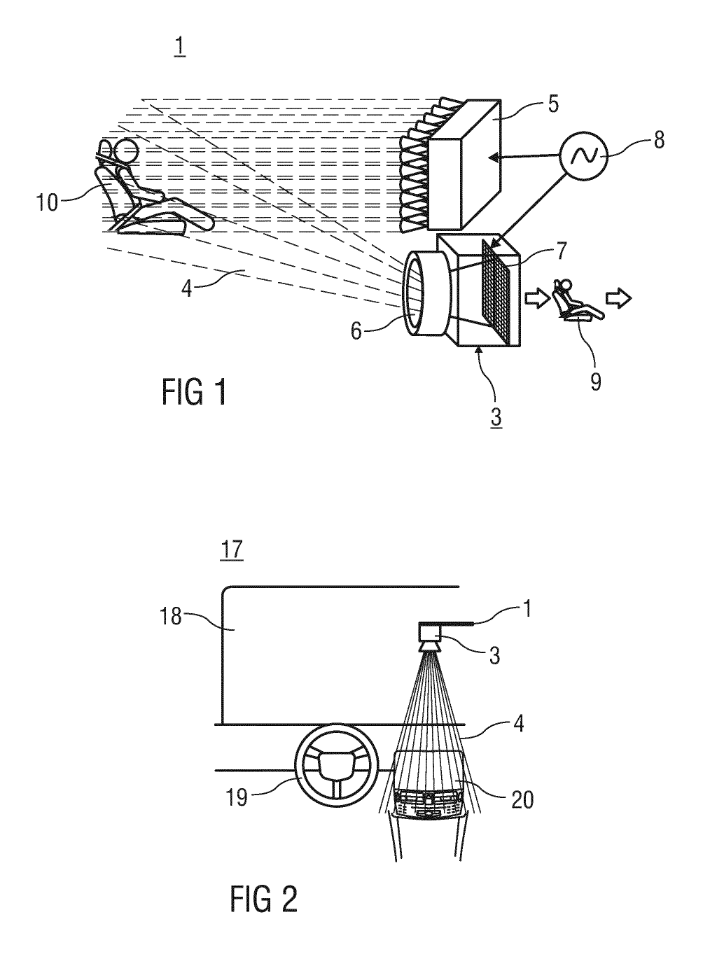

FIG. 1 schematically shows an illustration concerning the functional principle of the apparatus according to the invention,

FIG. 2 schematically shows an excerpt from a simulated vehicle interior with an apparatus for contactlessly detecting operating procedures of a display unit, and a display unit in front view,

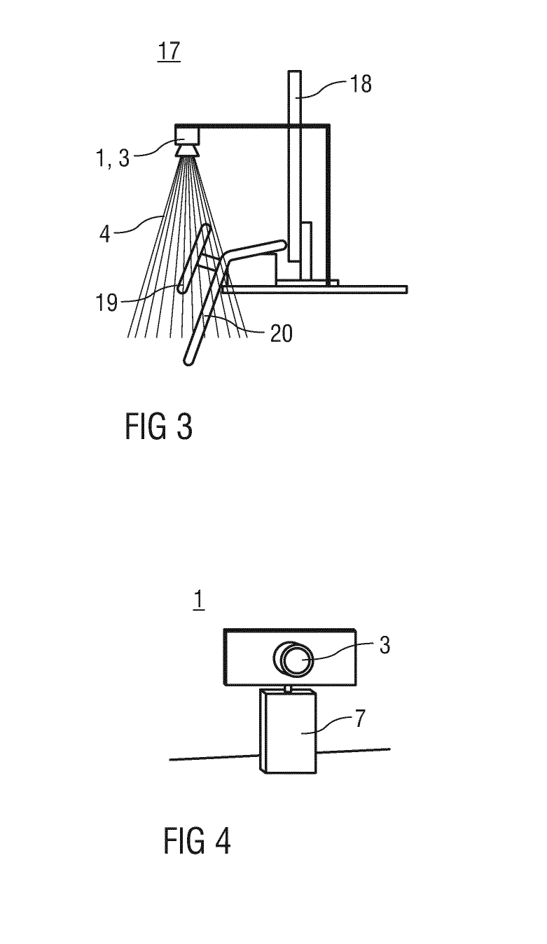

FIG. 3 schematically shows the excerpt from the simulated vehicle interior with the apparatus and display unit in accordance with FIG. 1 in side view,

FIG. 4 perspectively shows an optical detection unit in a preferred embodiment,

FIG. 5 schematically shows an illustration concerning the functional principle of the optical detection unit in the preferred embodiment in accordance with FIG. 4,

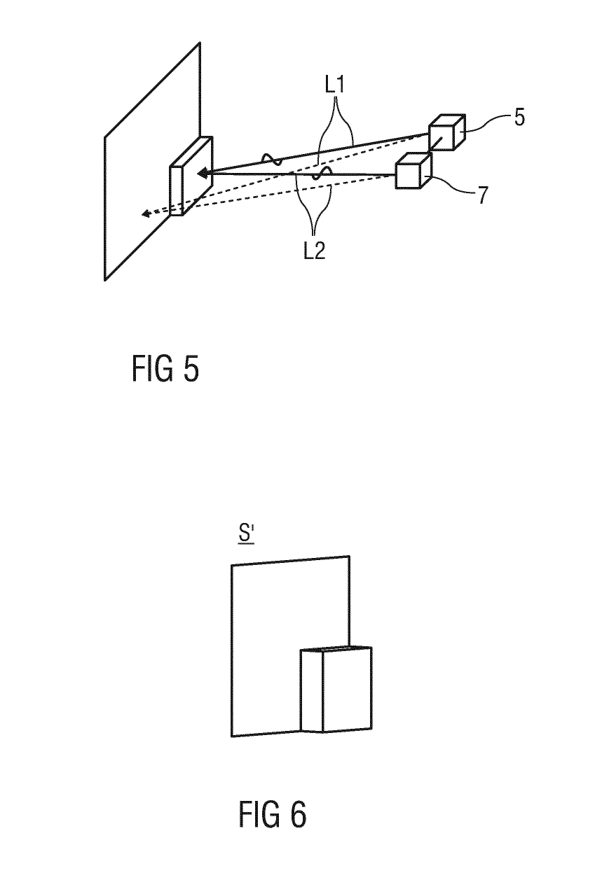

FIG. 6 schematically shows an output image of an optical sensor of the optical detection unit in accordance with FIG. 4,

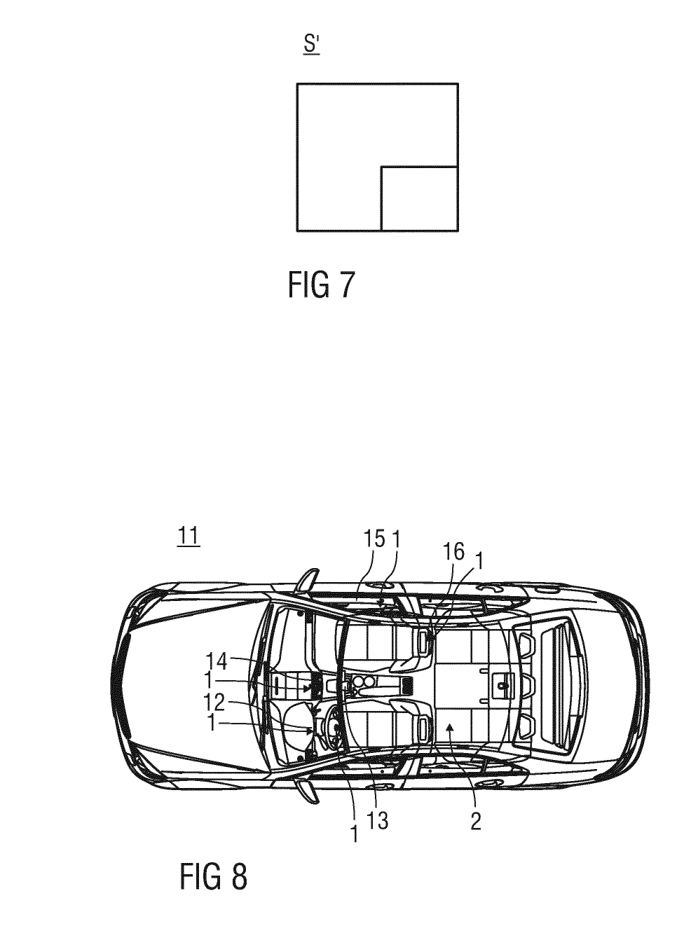

FIG. 7 schematically shows an excerpt from the output image in accordance with FIG. 6,

FIG. 8 schematically shows a plan view of a vehicle in a semitransparent illustration, and

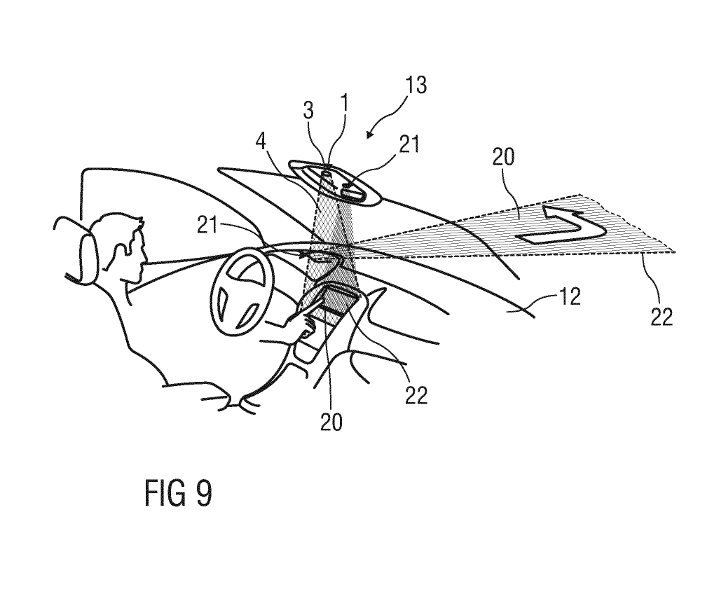

FIG. 9 schematically shows an exemplary embodiment of a use of the apparatus according to the invention in a vehicle.

Mutually corresponding parts are provided with the same reference signs in all the figures.

FIG. 1 schematically shows an illustration concerning the functional principle of the apparatus 1 according to the invention. The apparatus 1 is arranged in a vehicle interior 2, illustrated in FIG. 2, and oriented toward at least one vehicle occupant 10.

The apparatus 1 comprises at least one lighting unit 5 and an optical detection unit 3, by means of which an operating procedure, e.g. a hand movement for magnifying information represented (opening of hand), of a vehicle occupant 10 can be detected three-dimensionally in a predefinable detection region 4.

In one preferred embodiment, the optical detection unit 3 is designed as a so-called time-of-flight (TOF) camera comprising at least one optical element 6, at least one optical sensor 7 and corresponding electronics for driving and evaluation.

In this case, the lighting unit 5 serves for illuminating the detection region 4, which is preferably oriented toward a vehicle occupant 10. For this purpose, the lighting unit 5 comprises one or a plurality of light sources designed as conventional laser diodes, in particular infrared laser diodes. Preferably, the lighting unit 5 generates light in the infrared range in order that, for example, the vehicle occupants 10 are not adversely affected optically by the apparatus 1.

The optical sensor 7, which is preferably designed as a conventional photomixing detector, detects the time of flight separately for each pixel of the camera. In this case, the optical sensor 7 is integrated in the TOF camera or coupled thereto. By way of example, the optical sensor 7 can be arranged in the roof console of a vehicle. As an alternative thereto, the optical sensor 7 can also be oriented in the direction of the driver in an interior console or be arranged in the instrument panel or in a headrest of a vehicle.

By means of the optical element 6 of the optical detection unit 3, the illuminated detection region 4 can be imaged on the optical sensor 7. In other words, the optical element 6 is designed as an optical bandpass filter, for example, which allows passage of light only having the wavelength with which the detection region 4 is illuminated. Thus, disturbing light from the surroundings is eliminated or masked out to the greatest possible extent.

Both the lighting unit 5 and the optical detection unit 3 are driven by means of the driving electronics 8. The evaluation electronics 9 convert the detected operating procedure into a corresponding signal and communicate the latter to a control unit (not illustrated), which correspondingly carries out or actuates the desired operating procedure.

Particularly preferably, the optical detection unit 3 is designed as a stereo camera, in particular as an infrared stereo camera, by means of which an operating procedure can be optically detected three-dimensionally.

Depending on a shaping (not illustrated in more specific detail) of a diaphragm aperture of the optical detection unit 3 and/or a lens structure of the optical element 6, detected image regions can be used for example to detect a head movement of the vehicle driver, to detect a distraction of the vehicle driver from the current traffic situation, and/or to adjust a headrest on the basis of the detected head movement of the vehicle driver and/or to detect an incorrect position of the vehicle driver's head. For this purpose, a multifocal optical sensor can be used, for example, as optical sensor 7. Alternatively, an individual focus of the optical sensor can be pivoted by means of a movable optical system, e.g. a micromechanical system.

By way of example, if an incorrect position of the vehicle driver and/or a distraction from the current traffic situation are/is detected, then preferably corresponding actions, for example warning signals, can be activated, as a result of which traffic safety is improved, and/or information can be output on a display unit, for example a conventional combination display instrument.

FIGS. 2 and 3 show a simulated vehicle interior 17 in a schematic view. In this case, the viewing direction in FIG. 2 runs in the direction of a simulated windshield 18, on which a virtual traffic situation is imaged. FIG. 3 shows the simulated vehicle interior 17 in a side view.

A display unit 20 serving for displaying information and for operating functions is arranged laterally with respect to a steering wheel 19 arranged in the simulated vehicle interior 17. The display unit 20 is preferably designed as a combined display and input apparatus, in particular as a so-called head-up display or combined head-up display, also designated as combiner head-up display, for example for operating vehicle interior lighting and for displaying information concerning the lighting of the interior of a vehicle.

The display unit 20 is mechanically and/or electrically coupled, in a manner not illustrated in more specific detail, to an apparatus 1 for contactlessly detecting operating procedures of the display unit 20.

In this case, the apparatus 1 is arranged above the display unit 20 in the viewing direction. By way of example, the apparatus 1 can be arranged on or in a roof console of a vehicle.

The apparatus 1 comprises at least one optical detection unit 3 by means of which an operating procedure, e.g. a hand movement for magnifying represented information (opening of hand), of a vehicle occupant can be detected three-dimensionally in a predefinable detection region 4.

In one preferred embodiment, the optical detection unit 3 is designed as a so-called time-of-flight (TOF) camera comprising a lighting unit 5, at least one optical element 6, at least one optical sensor 7, which is illustrated in greater detail in FIG. 4, and the corresponding driving electronics 8 for driving and the corresponding evaluation electronics 9.

In this case, the lighting unit 5 coupled to the sensor 7 serves, in the manner already described, for illuminating the detection region 4, which is preferably situated directly in the vicinity of the display unit 20.

In a first alternative embodiment, the optical detection unit 3 is designed as a stereo camera, in particular as an infrared stereo camera, by means of which an operating procedure can be optically detected three-dimensionally.

In a second alternative embodiment, the optical detection unit 3 is designed as a so-called structured light scanner, in which an infrared light grid is applied to a vehicle occupant.

A display unit that is touch-sensitive by means of a conventional display unit 20 can be emulated by means of the apparatus 1, said display unit enabling an emulated capacitive proximity method, e.g. for distinguishing whether the display unit is operated by the driver or passenger. It is thus possible to emulate a so-called touch panel as center information display (for short: CID).

FIG. 4 shows an optical detection unit 3 designed as a TOF camera with the optical sensor 7 and the lighting unit 5 assigned thereto in a perspective view.

FIG. 5 schematically illustrates a functional principle of the optical detection unit 3 in the preferred embodiment in accordance with FIG. 4.

The functional principle is based on a time-of-flight method for distance measurement.

The lighting unit 5 emits a light signal L1 in the form of a diffuse light cone having modulated intensity, for example in the form of a sine, which illuminates a viewed scene S and is reflected by the latter. The wavelength of the emitted light signal L1 lies in the range of non-visible infrared light. The reflected light signal L2 is detected by the optical sensor 7. By means of a correlation of the emitted and reflected light signals L1, L2 it is possible to determine a phase shift corresponding to distance information. For this purpose, the photons received by the optical sensor 7 are converted into electrons in the photosensitive semiconductor region and are separated in different charge swings depending on distance. Consequently, the resulting output signal of each pixel establishes a direct relationship with the actual depth information of the viewed scene S. Preferably, the required time is proportional to the corresponding distance.

FIGS. 6 and 7 show an output of the scene S detected in FIG. 5, wherein FIG. 6 illustrates an excerpt from the output scene S′.

FIG. 8 shows a conventional vehicle interior 2 of a vehicle 11 illustrated in a semitransparent manner.

In the vehicle interior 2, the apparatus 1 according to the invention can be arranged for example in an instrument panel 12, a roof console 13, a center console 14, a door trim 15 and/or a headrest 16.

FIG. 9 shows various application examples for the apparatus 1 in the vehicle interior 2. In this case, in this exemplary embodiment, the apparatus 1 comprises as optical detection unit 3 an infrared camera, e.g. an infrared laser, in particular an infrared laser diode, with an assigned detection region 4 to be covered. For this purpose, the optical detection unit 3 is arranged in the region of the roof console 13, wherein the detection region 4 is oriented in the direction of the center console 14.

A conventional liquid crystal display, in particular a TFT screen, is arranged as a display unit 20 in the region of the center console 14.

Additionally or alternatively, a projection unit 21 with a projection region 22 can be provided in the region of the roof console 13 or in the region of the instrument panel 12, which projection unit can insert information in the region of the center console 14 or in the region of a windshield 22 and thus in the field of view of a vehicle occupant 10, e.g. of driver and/or passenger, on a further display unit 20, designed as a head-down display.

In this case, the respective or each further display unit in combination with the optical detection unit 3 can form a combined display and input apparatus. In this case, the detection region 4 of the detection unit 3 largely corresponds to the projection region of the projection unit 21. Consequently, actions and gestures of the vehicle occupant 10 performed within the detection region can be detected and used for controlling operating functions, virtual operating elements and/or virtual displays of the display unit 20.

As an alternative to a display unit 20 projected in the region of the center console, it is possible to realize said display unit on other interior parts and/or other display units or in a manner combined with projection as a touch panel.

In a further embodiment variant, by means of the apparatus 1 it is possible to emulate touch-sensitive operating elements on surfaces in the vehicle interior 2, for example on the instrument panel 12, on the roof console 13, the center console 14, the door trim 15 and/or the headrest 16. Conventional operating elements subject to wear and complex wirings are avoided as a result.

In a further possible embodiment variant, regions which initiate an operating procedure upon proximity or touch can be emulated by means of the apparatus 1 in a representation that is projected in a conventional manner.

In one advantageous embodiment variant, the apparatus 1 is designed so as to distinguish whether a vehicle driver or some other vehicle occupant 10 carries out an operating procedure in the vehicle. By way of example, in this way it is possible to distinguish whether the vehicle driver operates a navigation apparatus during the journey, from which a distraction from the traffic situation and a hazard could be identified, or some other vehicle occupant 10 operates the navigation apparatus. In one advantageous embodiment variant, by way of example, such an operating procedure of the vehicle driver can be suppressed or not carried out, whereas an operating procedure by some other vehicle occupant 10 is permitted.

In a further advantageous embodiment variant, operating procedures of a vehicle occupant 10 which concern a plurality of display means 20 can be detected by means of the apparatus 1. In this case, by way of example, represented contents and/or information can be shifted and/or exchanged between the different display means 20.

A further embodiment provides that the virtual displays can be manipulated in one of the display means 20. By way of example, represented information and/or displays can be magnified, reduced and/or controlled by corresponding action and/or gestures of the vehicle occupant 10. Moreover, represented displays and/or information from different display means 20 can be combined by contents of the displays being graphically combined when one of the displays is pushed over another display. Moreover, represented objects can be selected and moved and/or controlled.

In the case where at least one of the display means 20 is designed as an autostereoscopic unit, represented 3D displays can be manipulated by gestures and/or actions of the vehicle occupant in free space or in the detection space 4. By way of example, perspectives of represented 3D displays can be changed, for example rotated.

In a further advantageous embodiment variant (not illustrated), by means of the apparatus 1, opened vehicle windows and/or sliding sunroofs can be monitored and body parts of vehicle occupants 10 and/or objects arranged in the opening respectively produced as a result can be detected. Upon such detection of body parts and/or objects in the opening, the relevant vehicle window or sliding sunroof is prevented from closing.

In a further advantageous embodiment variant (not illustrated), by means of the apparatus 1, movements in the vehicle interior 2 can be monitored and detected movements in the case of a parked vehicle can be evaluated and can be forwarded to a conventional alarm system in the case of an identified undesirable intrusion in the vehicle interior 2.

All possibilities for use of the apparatus 1 as described above can be used alternatively or cumulatively.

### LIST OF REFERENCE SIGNS

1 Apparatus
2 Vehicle interior
3 Optical detection unit
4 Detection region
5 Lighting unit
6 Optical element
7 Optical sensor
8 Driving electronics
9 Evaluation electronics
10 Vehicle occupant
11 Vehicle
12 Instrument panel
13 Roof console
14 Center console
15 Door trim
16 Headrest
17 Simulated vehicle interior
18 Simulated windshield
19 Steering wheel
20 Display unit
21 Projection unit
22 Projection region
L1 Emitted light signal
L2 Reflected light signal
S Scene
S′ Scene that is output

1. An apparatus configured to be arranged in a vehicle interior and for contactlessly detecting objects and/or persons and gestures and/or operating procedures made and/or carried out thereby, the apparatus comprising:
at least one lighting unit;
a display unity; and
an optical detection unit,
wherein the lighting unit is formed horn at least one infrared laser.

2. The apparatus as claimed in claim 1, wherein the optical detection unit comprises at least one optical sensor.

3. The apparatus as claimed in claim 1, wherein the optical detection unit is designed as a three-dimensional camera system.

4. The apparatus as claimed in claim 3, wherein a time-of-flight method for distance measurement can be carried out by the optical detection unit.

5. The apparatus as claimed in claim 1, wherein the optical detection unit is designed as a stereo camera.

6. The apparatus as claimed in claim 2, wherein the at least one optical sensor is designed as a photomixing detector.

7. The apparatus as claimed in claim 2, wherein the optical sensor is integrated in a three-dimensional camera system or a stereo camera or is coupled thereto.

8. The apparatus as claimed in claim 1, wherein the display unit is designed as a head-up display in a vehicle driver's field of view.

9. A method for contactlessly detecting objects and/or persons and gestures and/or operating procedures made and/or carried out thereby, comprising:
using an optical detection unit to detect three-dimensionally in a vehicle interior an object and/or a person and/or gestures and/or operating procedures made and/or carried out by said person.

10. The method as claimed in claim 9, wherein a touch-sensitive display unit is emulated by an apparatus, said display unit enabling an emulated capacitive proximity method for distinguishing whether the display unit is operated by a vehicle driver or some other vehicle occupant.

11. The method as claimed in claim 9, wherein virtual displays of the display unit are manipulated, in particular shifted, exchanged, rotated and/or controlled, by actions and/or gestures made by a person in the vehicle interior.

12. The use of an apparatus as claimed in claim 1 for representing and manipulating virtual images on a display unit.

13. The use of an apparatus as claimed in claim 1 for operating virtual operating elements generated on a display unit.

14. The use of an apparatus as claimed in claim 1 for monitoring and safeguarding a vehicle interior and/or openings in the vehicle with regard to an undesirable intrusion.
